(19) United States
(12) Patent Application Publication
(10) Pub. No.: US 2013/0332201 A1
(43) Pub. Date: Dec. 12, 2013

(54) DATA ACQUISITION APPARATUS CONFIGURED TO ACQUIRE DATA FOR INSURANCE PURPOSES, AND RELATED SYSTEMS AND METHODS

(71) Applicants: Peter L. Hagelstein, Carlisle, MA (US); Roderick A. Hyde, Redmond, WA (US); Muriel Y. Ishikawa, Livermore, CA (US); Jordin T. Kare, Seattle, WA (US); Lowell L. Wood, JR., Bellevue, WA (US); Victoria Y.H. Wood, Livermore, CA (US)

(72) Inventors: Peter L. Hagelstein, Carlisle, MA (US); Roderick A. Hyde, Redmond, WA (US); Muriel Y. Ishikawa, Livermore, CA (US); Jordin T. Kare, Seattle, WA (US); Lowell L. Wood, JR., Bellevue, WA (US); Victoria Y.H. Wood, Livermore, CA (US)

(21) Appl. No.: 13/494,190

(22) Filed: Jun. 12, 2012

(51) Int. Cl. G06Q 40/08

(52) U.S. Cl. 705/4

(57) ABSTRACT

Embodiments disclosed herein are directed to data acquisition apparatuses configured to acquire insurance-related data from an insurance policyholder for insurance purposes and transmit the insurance-related data directly or indirectly to an insurer of insurance for the insurance policyholder, and related systems and methods.

### SUMMARY

Embodiments disclosed herein are directed to data acquisition apparatuses configured to acquire insurance-related data from an insurance policyholder for insurance purposes and transmit the acquired insurance-related data directly or indirectly to an insurer of insurance for the insurance policyholder, and related systems and methods. The data acquisition apparatuses may function, for example, as “insurance black boxes” for collecting physiological data about the insurance policyholder. The insurance-related data may be used by the insurer in determining insurance coverage or insurance rates for the insurance policyholder.

In an embodiment, a data acquisition apparatus for collecting insurance-related information includes memory, a data acquisition unit operably coupled to the memory, and at least one processor having access to the memory. The memory includes personal identification information stored thereon, with the personal identification information being associated with insurance of an insurance policyholder. The memory is configured to store physiological data thereon acquired by the data acquisition unit. The data acquisition unit is configured to acquire the physiological data associated with the insurance policyholder with which the data acquisition unit is configured to be physically associated. The at least one processor is configured to instruct a data transmitter to transmit one or more data signals from the insurance policyholder that encode the personal identification information and information related to at least part of the acquired physiological data.

In an embodiment, a data acquisition apparatus for collecting insurance-related information includes memory, a data acquisition unit, and a data transmitter having access to the memory and coupled to the data acquisition unit. The memory includes personal identification information stored thereon, with the personal identification information being associated with insurance of an insurance policyholder. The data acquisition unit is configured to acquire physiological data associated with the insurance policyholder with which the data acquisition unit is configured to be physically associated. The data transmitter is configured to transmit one or more data signals from the insurance policyholder that encode the personal identification information and information related to at least part of the acquired physiological data.

In an embodiment, a computer system includes a data receiver configured to receive one or more signals encoding personal identification information associated with insurance of an insurance policyholder, and physiological data associated with the insurance policyholder. The computer system further includes memory having an insurance database stored thereon. The insurance database includes information about a plurality of insurance policies and respective identities of the corresponding insurance policyholders. The computer system also includes processing electrical circuitry operably coupled to the data receiver and the memory. The processing electrical circuitry is configured to associate the acquired physiological data with the insurance of the insurance policyholder identified by the personal identification information encoded in the one or more signals.

In an embodiment, a computer program product includes a computer readable medium. The computer readable medium includes computer executable instructions stored thereon that, when executed by at least one processor, perform a method. The method includes accessing information stored in memory of a data acquisition apparatus physically associated with an insurance policyholder. The information includes personal identification information associated with insurance of the insurance policyholder. The method further includes directing a data transmitter to transmit one or more data signals from the insurance policyholder. The one or more data signals encode the personal identification information and information related to at least part of physiological data from the insurance policyholder.

In an embodiment, a system includes a data acquisition apparatus configured to be physically associated with an insurance policyholder. The data acquisition apparatus includes memory, a data acquisition unit, and a data transmitter operably coupled to the data acquisition unit and the memory. The memory has personal identification information stored thereon, with the personal identification information being associated with insurance of the insurance policyholder. The data acquisition unit is configured to acquire physiological data associated with the insurance policyholder with which the data acquisition unit is configured to be physically associated. The data transmitter is configured to transmit one or more data signals encoding the personal identification information, and information related to at least part of the acquired physiological data. The system further includes a computing device having a data receiver configured to receive the one or more data signals, and memory having an insurance database stored thereon. The insurance database includes information about the insurance of the insurance policyholder.

In an embodiment, a method includes receiving physiological data associated with an insurance policyholder. The physiological data is collected from a data acquisition apparatus physically associated with the insurance policyholder. The method further includes transmitting one or more data signals from the insurance policyholder. The one or more data signals encode personal identification information associated with insurance of the insurance policyholder and information related to at least part of the physiological data.

In an embodiment, a method includes receiving one or more data signals transmitted from a data acquisition apparatus physically associated with the insurance policyholder. The one or more data signals encode personal identification information associated with insurance of an insurance policyholder and information related to physiological data collected with the data acquisition apparatus. The method further includes associating the information with the insurance of the insurance policyholder identified by the personal identification information encoded in the one or more signals.

The foregoing is a summary and thus may contain simplifications, generalizations, inclusions, and/or omissions of detail; consequently, the reader will appreciate that the summary is illustrative only and is NOT intended to be in any way limiting. Other aspects, features, and advantages of the devices and/or processes and/or other subject matter described herein will become apparent after reading the teachings set forth herein.

### BRIEF DESCRIPTION OF THE FIGURES

FIG. 1 is schematic diagram of an insurance policyholder including a data acquisition apparatus implanted therein that is configured to acquire physiological data for insurance purposes according to an embodiment.

FIG. 2A is a functional block diagram of an embodiment of the data acquisition apparatus shown in FIG. 1.

FIG. 2B is a functional block diagram of an embodiment of a data acquisition apparatus that employs an electrical interface for transmitting collected data.

FIG. 3A is a functional block diagram of an embodiment of a system including the data acquisition apparatus shown in FIG. 2A and an insurer's computer system configured to associate the insurance-related data received from the data acquisition apparatus with an insurance policy of the insured.

FIG. 3B is a functional block diagram of an embodiment of a system including the data acquisition apparatus shown in FIG. 2A further configured to wirelessly receive instructions from an insurer's computer system configured to associate the insurance-related data received from the data acquisition apparatus with an insurance policy of the insured.

FIG. 4 is a functional block diagram of a data acquisition apparatus according to another embodiment.

FIG. 5 is a functional block diagram of an embodiment of a data acquisition apparatus that transmits acquired physiological data in real time.

FIG. 6 is a flow diagram illustrating an embodiment of a method that may be implemented by any of the data acquisition apparatuses disclosed herein.

FIG. 7 is a flow diagram illustrating an embodiment of another method that may be implemented by one or more of the data acquisition apparatuses disclosed herein.

FIG. 8 is a flow diagram illustrating an embodiment of a method that may be implemented by any of the insurer computer systems disclosed herein.

### DETAILED DESCRIPTION

Embodiments disclosed herein are directed to data acquisition apparatuses configured to acquire insurance-related data from an insurance policyholder for insurance purposes and transmit the acquired insurance-related data directly or indirectly to an insurer of insurance for the insurance policyholder, and related systems and methods. The data acquisition apparatuses may function, for example, as “insurance black boxes” for collecting physiological data about the insurance policyholder. The insurance-related data may be used by the insurer in determining insurance coverage or insurance rates for the insurance policyholder.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein.

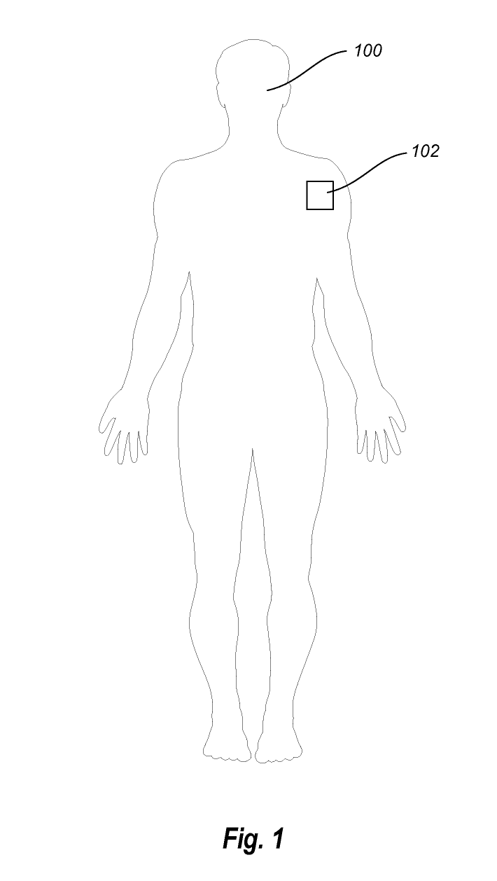

FIG. 1 is schematic diagram of an insurance policyholder 100 having a data acquisition apparatus 102 implanted therein for physical association with the insurance policyholder 100, which is configured to acquire insurance-related data according to an embodiment. As will be discussed in more detail below, the data acquisition apparatus 102 is configured to collect physiological data from the insurance policyholder 100, and transmit the collected data to an insurer that insures insurance of the insurance policyholder 100.

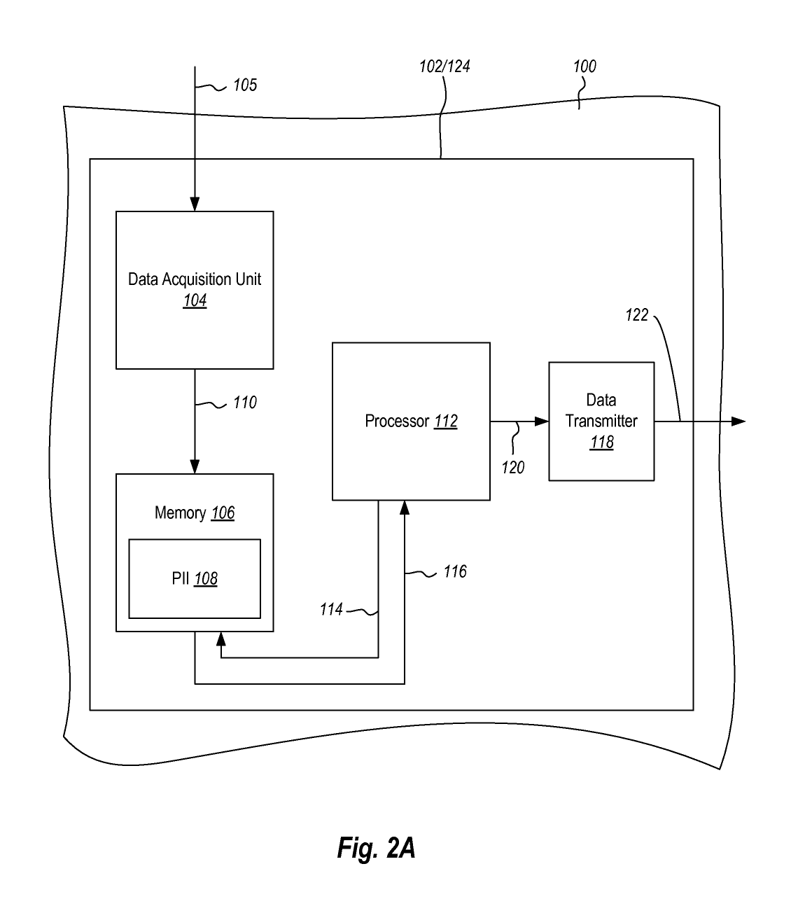

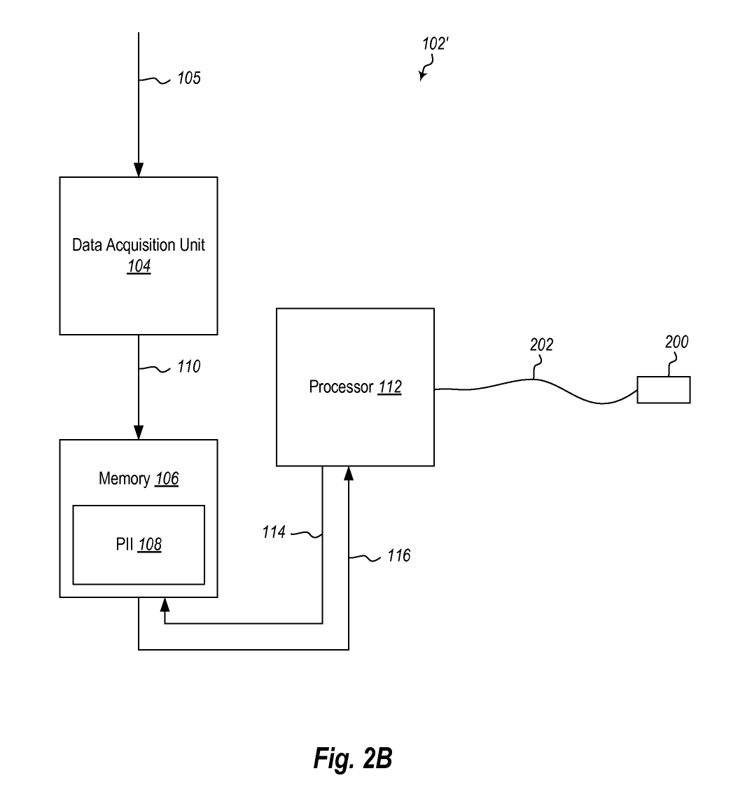

Referring now to the functional block diagram of an embodiment for the data acquisition apparatus 102 shown in FIG. 2A, the structure and operation of the data acquisition apparatus 102 will be more fully understand. The data acquisition apparatus 102 includes a data acquisition unit 104 configured to acquire physiological data associated with the insurance policyholder 100 (represented as one or more acquired data signals 105).

The physiological data acquired may include, for example, heart rate of the insurance policyholder 100, blood-alcohol content of the insurance policyholder 100, blood chemistry of the insurance policyholder 100, blood pressure of the insurance policyholder 100, or temperature of the insurance policyholder 100.

For example, the data acquisition unit 104 may include at least one of a heart rate sensor, a blood-alcohol content sensor, a blood chemistry sensor, a blood pressure sensor, a temperature sensor, or a nerve activity sensor, configured to collect the physiological data. The different sensors are configured to acquire different types of physiological information associated with the insurance policyholder 100. As can be appreciated from the foregoing different sensors, the heart rate sensor acquires one or more heart rate signals of the insurance policyholder 100, the blood-alcohol content sensor acquires one or more signals that correlate to blood alcohol content of the insurance policyholder 100, the temperature sensor acquires one or more temperature measurements of the insurance policyholder 100, or the nerve activity sensor acquires one or more signals related to nerve activity.

The data acquisition apparatus 102 further includes memory 106 coupled to the data acquisition unit 104. The memory 106 includes memory electrical circuitry. For example, the memory 106 may be in the form of non-volatile memory or other suitable memory. The memory 106 includes personal identification information (“PII”) 108 stored thereon associated with insurance of an insurance policy insuring the insurance policyholder 100. For example, the PII 108 may include at least one of an insurance policy number of the insurance of the insurance policyholder 100, a social security number of the insurance policyholder 100, a device identifier (e.g., a device serial number or other suitable identifier) of the data acquisition apparatus 102, a name of an insurer insuring the insurance policyholder 100, or a name of the insurance policyholder 100.

In operation, the one or more acquired data signals 105 received by the data acquisition unit 104 are transmitted to the memory 106 as one or more data signals 110. The acquired physiological data may be stored in the memory 106 and accessed at a later time.

The data acquisition apparatus 102 further includes at least one processor 112 operably coupled to the memory 106. The at least one processor 112 may include processing electrical circuitry configured to send one or more memory access signals 114 to the memory 106 and, responsive thereto, receive one or more memory data signals 116 from the memory 106 encoding the PII 108 and the acquired physiological data acquired by the data acquisition unit 104.

The data acquisition apparatus 102 also includes a data transmitter 118 that is operably coupled to the at least one processor 112. Responsive to receiving the one or more memory data signals 116 from the memory 106, the at least one processor 112 transmits one or more data signals 120 encoding the PII 108 and the acquired physiological data acquired by the data acquisition unit 104, which the data transmitter 118 transmits as one or more insurance data signals 122 out of the insurance policyholder 100 that encode the PII 108 and information related to at least part of the acquired physiological data. For example, the one or more insurance data signals 122 may be in the form of a packet with the PII 108 in a header and the information related to at least part of the acquired physiological data may be in the body or payload of the packet.

The data transmitter 118 may be chosen from a number of different suitable data transmitters. For example, the data transmitter 118 may include at least one of a radio-frequency transmitter, an optical transmitter, or an ultrasound transmitter. For example, the radio-frequency transmitter is configured to transmit the one or more insurance data signals 122 as one or more radio-frequency signals. The optical transmitter is configured to transmit the one or more insurance data signals 122 as one or more optical signals in the infrared or ultra-violet wavelength range. In the embodiment illustrated in FIGS. 1 and 2A in which the data acquisition apparatus 102 is implanted in the insurance policyholder 100, the data transmitter 118 is configured so wavelength(s) of the one or more insurance data signals 122 are transdermally transmittable out of the insurance policyholder 100. For example, the one or more insurance data signals 122 are transdermally transmittable out of the insurance policyholder 100 through muscles, tissue, or other biological matter of the insurance policyholder 100.

In an embodiment, the data acquisition unit 104 acquires data that has been specified by the insurer of the insurance covering the insurance policyholder 100. For example, the data acquisition apparatus 102 may be provided by or owned by the insurer, and provided to the insurance policyholder 100 based requirements of the insurance policy, or as an option for the insurance policyholder 100 to receive a reduce premium on the insurance policy. As another example, the data acquisition unit 104 may be configured by the electrical circuitry configuration therein, software, or firmware to only collect specific information and based on specific collection protocols set or programmed by the insurer.

In an embodiment, the processing electrical circuitry of the at least one processor 112 may be configured to perform statistical analysis on the one or more memory data signals 116 received from the memory 106 encoding the PII 108 and the acquired physiological data acquired by the data acquisition unit 104. For example, the processing electrical circuitry may be configured to calculate an average of at least one type of measurement over a specific time period or a moving average, a standard deviation of at least one type of measurement over a specific time period, or other selected statistical calculation. In such an embodiment, the one or more data signals 120 output from the at least one processor 112 and the one or more data signals 122 output from the data transmitter 118 may each include the PII 108, results of the statistical calculation, and, in some cases, the raw acquired data that was analyzed by the at least one processing electrical circuitry.

The data acquisition apparatus 102 is shown in FIGS. 1 and 2A as being implanted in the insurance policyholder 100 for physical association with the insurance policyholder 100. Thus, at least one of the data acquisition unit 104, memory 106, at least one processor 112, or data transmitter 118 of the data acquisition apparatus 102 may be enclosed in a suitable biocompatible packaging 124 (e.g., a biocompatible housing) that protects the components of the data acquisition apparatus 102, is biocompatible with the insurance policyholder 100, and is suitably sized to be implanted in the insurance policyholder 100. The biocompatible protective packaging 124 may be formed from a number of different biocompatible polymeric materials, such as at least one of polyxylene, polyethylene, poly(ethylene oxide), polyurethane, or poly(butylene terephthalate). The biocompatible protective packaging 124 may also be formed from a number of different biocompatible ceramics (e.g., silicate-based ceramics) or biocompatible metallic materials such as titanium, titanium alloys, or stainless steels. In an embodiment, the biocompatible protective packaging 124 may be in the form of a biocompatible coating made from at least one of the aforementioned biocompatible polymeric, ceramic, or metallic materials and formed over a relatively less biocompatible housing that provides structural support for the biocompatible coating or a housing formed from at least one of the aforementioned biocompatible materials.

However, in one or more embodiments, the data acquisition apparatus 102 may be worn, attached to (e.g., by adhesive), or otherwise physically associated with the insurance policyholder 100 instead of being implanted in order to collect physiological data associated with the insurance policyholder 100. Physical association with the insurance policyholder 100 includes the data acquisition apparatus 102 being implanted in the insurance policyholder 100 as previously described, the data acquisition apparatus 102 being attached temporarily to the insurance policyholder 100 (e.g., by adhesive or straps), or the data acquisition apparatus 102 being attached semi-permanently to the insurance policyholder 100 (e.g., by cement or bone screws). For example, the element 124 shown in FIG. 2A may be configured as a housing having one or more straps attached thereto for temporarily securing the data acquisition apparatus 102 to the insurance policyholder 100. Depending on the type of data desired or needed to be collected from the insurance policyholder 100, it may not be necessary to actually implant the data acquisition apparatus 102 into the insurance policyholder 100. For example, the data acquisition unit 104 does not need to be implanted when the data acquisition unit 104 is a blood pressure sensor or a temperature sensor. However, such sensors may also be employed in an implantable data acquisition apparatus, if desired or needed.

Now that the structure and operation of one or more embodiments of a data acquisition apparatus suitable for acquiring physiological information about the insurance policyholder 100 has been explained, one or more systems will be described that includes the data acquisition apparatus and an insurer's computer system that processes the one or more insurance data signals 122 received from the data acquisition apparatus 102.

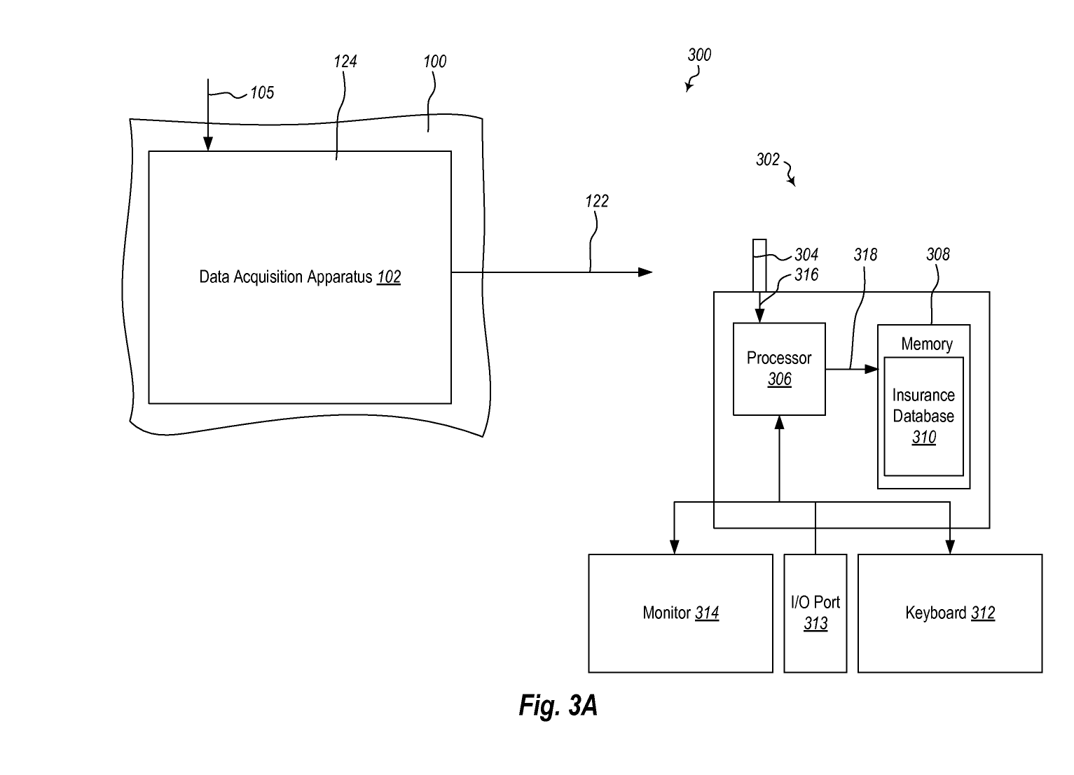

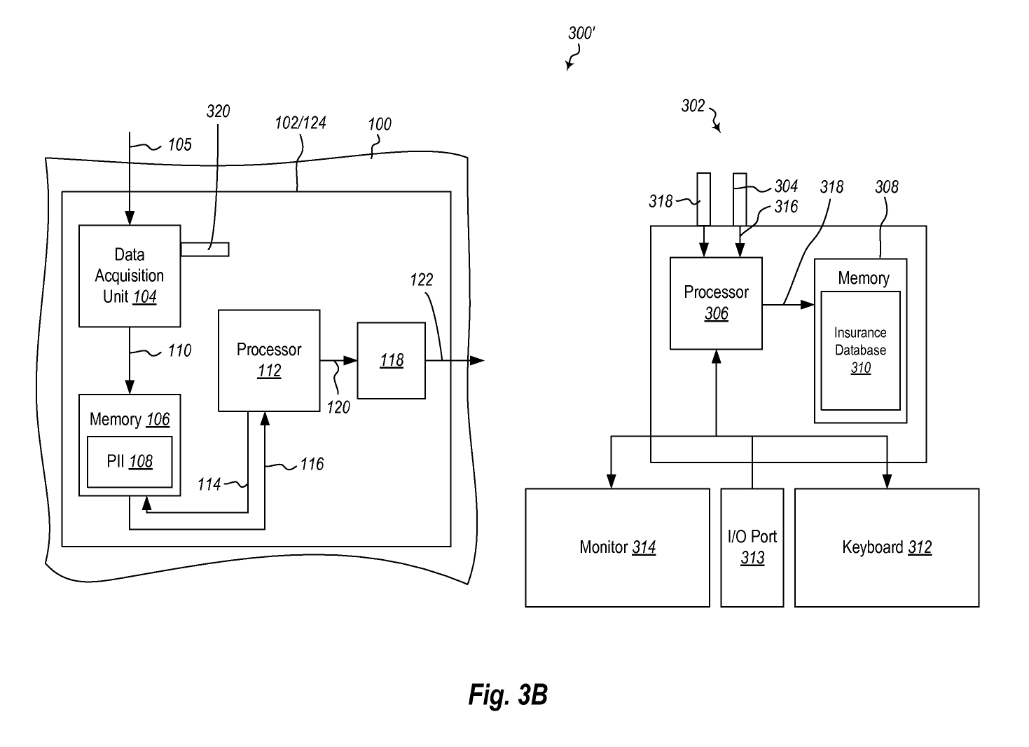

FIG. 3A is a functional block diagram of an embodiment of a system 300 including the data acquisition apparatus 102 shown in FIG. 2A and an insurer's computer system 302 configured to receive the one or more insurance data signals 122 and associate the insurance-related data with an insurance policy of the insurance policyholder 100.

The data acquisition apparatus 102 collects and transmits the one or more insurance data signals 122 encoding the PII 108 and the information related to the at least part of the acquired physiological data or other statistically processed data as previously described with respect to FIGS. 1 and 2A. In the interest of brevity, a description of the operation and structure of the data acquisition apparatus 102 is not repeated again herein.

The computer system 302 includes a data receiver 304 operably coupled to at least one processor 306. For example, the data receiver 304 may be configured as a wireless receiver, such as a radio-frequency receiver, an optical receiver, an ultrasound receiver, or other suitable type of receiver that is complementary configured based on the wavelength(s) of the one or more insurance data signals 122 to receive the one or more insurance data signals 122. The at least one processor 306 is also operably coupled to memory 308. The memory 308 includes an insurance database 310 stored thereon containing information about a plurality of insurance policies and respective identities of the corresponding insurance policyholders for the insurance policies.

The at least one processor 306 includes processing electrical circuitry configured to associate the information related to at least part of the acquired physiological data encoded in the one or more insurance data signals 122 based on the PII 108 encoded in the one or more insurance data signals 122. For example, the association may be performed by hardware, software, or firmware included in or associated with the processing electrical circuitry of the at least one processor 306. The information related to the at least part of the acquired physiological data encoded in the one or more insurance data signals 122 is also stored in the insurance database 310 so that the information for the insurance policyholder 100 is updated.

A keyboard 312 (or other input device) and one or more input/output (“I/O”) ports 313 are also provided, which are operably coupled to the at least one processor 306 along with a monitor 314 or other output device. For example, the I/O port 313 may be configured to receive an electrical connector such as a USB plug or configured as another suitable electrical interface. As can be appreciated, the keyboard 312 enables the insurer to manipulate the information in the updated insurance database 310 and view the insurance database 310 or selected portions thereof on the monitor 314. Based on evaluating the updated information related to the at least part of the acquired physiological data encoded in the one or more insurance data signals 122, the insurer may choose to modify or not to modify the insurance policyholder's 100 insurance based on the risk assessed from evaluating the collected physiological data.

In operation, the wireless receiver 304 receives the one or more insurance data signals 122 output from the data acquisition apparatus 102 implanted in the insurance policyholder 100. The wireless receiver 304 transmits one or more data signals 316 to the at least processor 306, which also encodes the information related to the at least part of the acquired physiological data encoded in the one or more insurance data signals 122. The at least one processor 306 then transmits one or more memory data signals 318 to the memory 308 so that the information related to the at least part of the acquired physiological data encoded in the one or more insurance data signals 122 output by the data acquisition apparatus 102 may be stored in the memory 308 such as in the insurance database 310. The processing electrical circuitry of the at least one processor 306 may associate the information with the insurance policy for the insurance policyholder 100 before or after the one or more memory data signals 318 are transmitted to the memory 308.

In the data acquisition apparatus 102 shown in FIGS. 1 and 2A, the one or more insurance data signals 122 are transmitted wirelessly to the data receiver 304. However, in an embodiment, the data transmitter 118 may be replaced with a suitable electrical interface. For example, FIG. 2B is a functional block diagram of an embodiment of a data acquisition apparatus 102′ that employs an electrical interface for transmitting collected data. Instead of employing the data transmitter 118 for transmitting acquired data, an electrical interface 200 is operably coupled to the at least one processor 112 via one or more wires 202. The electrical interface 200 may be configured as an electrical socket, an electrical plug as illustrated (e.g., a UBS plug), or other suitable wired data receiver.

In such an embodiment, the information related to the at least part of the acquired physiological data encoded in the one or more insurance data signals 122 and the PII 108 stored in the memory 106 may be downloaded at a selected time by the insurer or other party by connecting the electrical interface 200 to the I/O port 313 along with hardware, software, or firmware of the at least one processor 306 being configured to extract the stored data in the memory 106. In such an embodiment, the I/O port 313 functions as a data receiver and the electrical interface 200 functions as a data transmitter. Because of the electrical interface 200, the data acquisition apparatus 102′ is well suited to be worn as opposed to being implanted.

Although the data acquisition apparatus 102 is shown in FIG. 3A as directly transmitting the one or more insurance data signals 122 to the insurer's computer system 300, in one or more embodiments, the one or more insurance data signals 122 may be indirectly transmitted to insurer's computer system 300. For example, the one or more insurance data signals 122 may be transmitted to an intermediate computer server or router that routes the one or more insurance data signals 122 to the insurer's computer system 300. In some embodiments, the intermediate computer server or router may be owned or controlled by the insurer. In other embodiments, the intermediate computer server or router may be owned or controlled by another independent third party.

In some applications, the insurer may desire to have the capability to remotely configure the data acquisition apparatus worn or implanted by the insurance policyholder. FIG. 3B is a functional block diagram of an embodiment of the system 300′ including the data acquisition apparatus 102 shown in FIG. 2A further configured to wirelessly receive instructions from an insurer's computer system 302′. In the embodiment illustrated in FIG. 3B, the data acquisition unit 104 is further operably coupled to a wireless receiver 320 and the at least one processor 306 of the insurer's computer system 302 is operably coupled to a wireless transmitter 318. In operation, the wireless transmitter 318 may wirelessly communicate with the data acquisition unit 104 via the wireless receiver 320.

In an embodiment, the wireless transmitter 318 may wirelessly communicate operational instructions (e.g., initial or new operating instructions) to the data acquisition unit 104 via the wireless receiver 320, such as frequency of measurements to be taken by the data acquisition unit 104, frequency of transmission of the one or more insurance data signals 122 by the data transmitter 118, or type of measurements (e.g. type of physiological measurements) to be taken by the data acquisition unit 104. For example, the operating instructions may direct the frequency or type of physiological measurements the data acquisition apparatus 102 is to perform.

For example, the operational instructions may provide a schedule by which the at least one processor 112 of the data acquisition apparatus 102 is to instruct the data transmitter 118 to output the one or more data signals 122 encoding the PII 108 and the information related to the acquired physiological data. In an embodiment, the wireless transmitter 318 may wirelessly query the data acquisition unit 104 via the wireless receiver 320 for collected data and, responsive to the query, the at least one processor 112 instructs the data transmitter 118 to transmit the one or more insurance data signals 122 encoding the PII 108 and the information related to the at least part of the acquired physiological data.

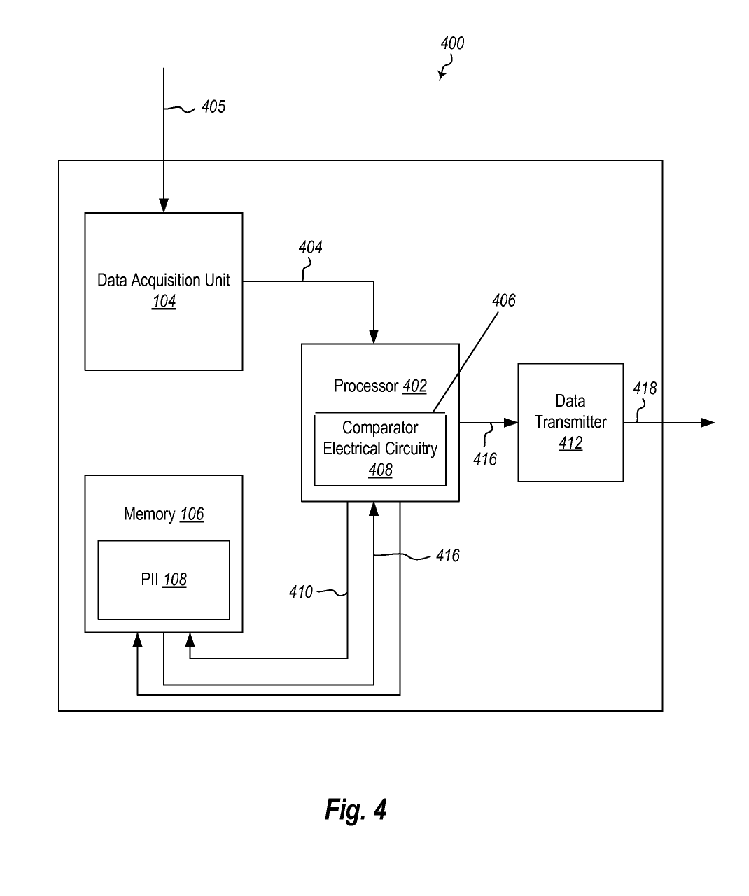

FIG. 4 is a functional block diagram of an embodiment of a data acquisition apparatus 400 configured to compare acquired data to conditions specified by an insurer. The data acquisition apparatus 400 includes one of the data acquisition units 104 configured to acquire physiological data associated with the insurance policyholder 100 (represented as one or more acquired data signals 405). The data acquisition apparatus 102 further includes the memory 106. The memory 106 includes the PII 108 stored thereon associated with insurance of an insurance policy insuring the insurance policyholder.

The data acquisition apparatus 400 further includes at least one processor 402 operably coupled to the memory 106 and to the data acquisition unit 104. In operation, the one or more acquired data signals 405 received by the data acquisition unit 104 are transmitted to the at least one processor 402 as one or more data signals 404.

The at least processor 402 further includes a comparator 406 including comparator electrical circuitry 408 configured to compare the one or more data signals 404 to conditions specified by the insurer. In an embodiment, the comparator electrical circuitry 408 may determine if the acquired physiological data is a type of data specified by the insurer. Based on instructions 410 transmitted from the at least one processor 402, the memory 106 may store at least part of the acquired physiological data therein if it is the type of data specified by the insurer and to not store the at least part of the acquired physiological data if is not the type of data specified by the insurer.

The data acquisition apparatus 400 also includes a data transmitter 412 that may be configured the same or similarly as the data transmitter 118 shown in FIG. 2A. The data transmitter 412 is operably coupled to the at least one processor 402. Responsive to one or more memory access signals 414 output from the at least one processor 402 to the memory 106, the at least one processor 402 receives one or more memory data signals 416 output from the memory 106 encoding the PII 108 and the acquired physiological data acquired by the data acquisition unit 104. The at least one processor 402 then transmits the one or more memory data signals 416 to the data transmitter 412, which outputs the one or more memory data signals 416 as one or more insurance data signals 418 encoding the PII 108 and information related to the at least part of the acquired physiological data.

In an embodiment, the comparator electrical circuitry 408 is configured to compare the information to a predetermined condition or a plurality of predetermined conditions. In such an embodiment, the at least one processor 402 selectively transmits the one or more data signals 416 to the data transmitter 412 only if the predetermined condition or plurality of predetermined conditions occurs. For example, the predetermined condition may be a threshold physiological condition, such as a maximum heart rate, maximum temperature of the insurance policyholder, or maximum blood pressure, and may be at least partially based upon a plurality of the acquired physiological data values.

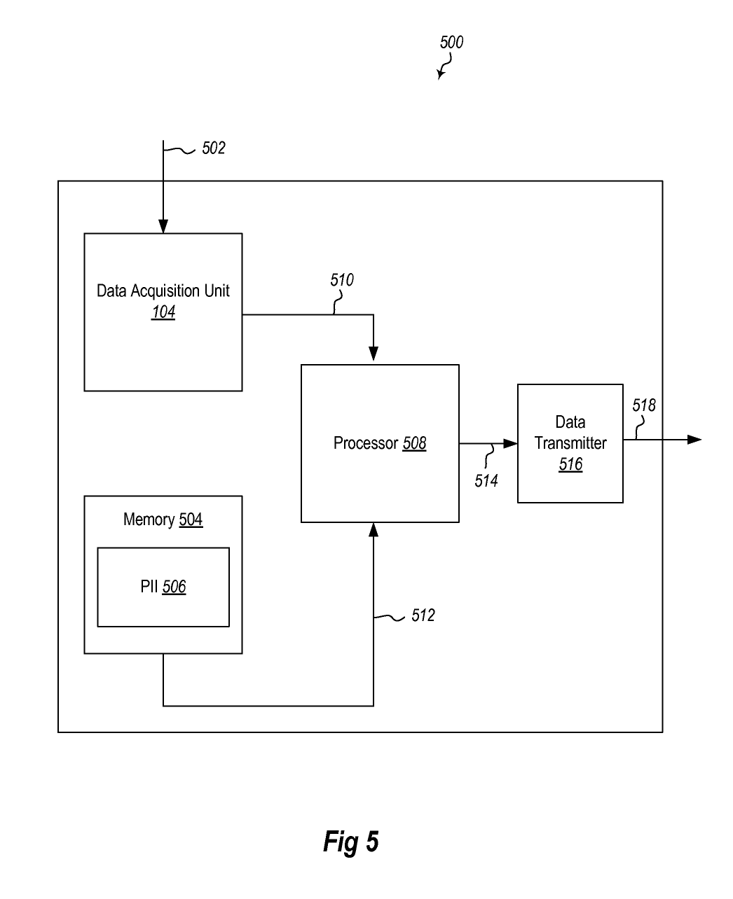

The data acquisition apparatus 102 shown in FIG. 2A, the data acquisition apparatus 102′ shown in FIG. 2B, and the data acquisition apparatus 400 shown in FIG. 4 store acquired data collected by the data acquisition unit 104 in the memory 106 and transmit at least a portion of such data in raw or processed form. Referring to FIG. 5, in an embodiment, the acquired data collected by the data acquisition unit 104 may be transmitted in real-time without storing in memory. FIG. 5 is a functional block diagram of an embodiment of a data acquisition apparatus 500 that transmits acquired physiological data in real time.

The data acquisition apparatus 500 includes one of the data acquisition units 104 configured to acquire physiological data associated with the insurance policyholder (represented as one or more acquired data signals 502).

The data acquisition apparatus 500 further includes memory 504 coupled to the data acquisition unit 104. The memory 504 includes PII 506 stored thereon associated with insurance of an insurance policy insuring the insurance policyholder. For example, the PII 506 may include at least one of an insurance policy number of the insurance of the insurance policyholder, a social security number of the insurance policyholder, a device identifier of the data acquisition apparatus 500, a name of an insurer insuring the insurance policyholder, or a name of the insurance policyholder.

The data acquisition apparatus 500 further includes at least one processor 508 operably coupled to the memory 504 and the data acquisition unit 104. The at least one processor 508 is operably coupled to the data acquisition unit 104 and receives, in operation, one or more data signals 510 encoding the acquired physiological data acquired by the data acquisition unit 104 output from the data acquisition unit 104 and a PII signal 512 output from the memory 504 that encodes the PII 506 stored in the memory 504. The at least one processor 508 is further configured to combine the one or more data signals 510 and the PII signal 512 into one or more data signals 514 that are transmitted to a data transmitter 516. The data transmitter 516 transmits the one or more data signals 514 as one or more insurance data signals 518 that are transdermally transmittable out of the insurance policyholder. For example, the one or more data signals 514 and the one or more insurance data signals 516 may each be in the form of a packet with the PII 506 in a header and the information related to at least part of the acquired physiological data may be in the body or payload of the packet.

It should be noted that the data acquisition apparatuses 400 and 500 may be employed in the system 300 shown in FIGS. 3A and 3B as an alternative to the data acquisition apparatus 102 or 102′.

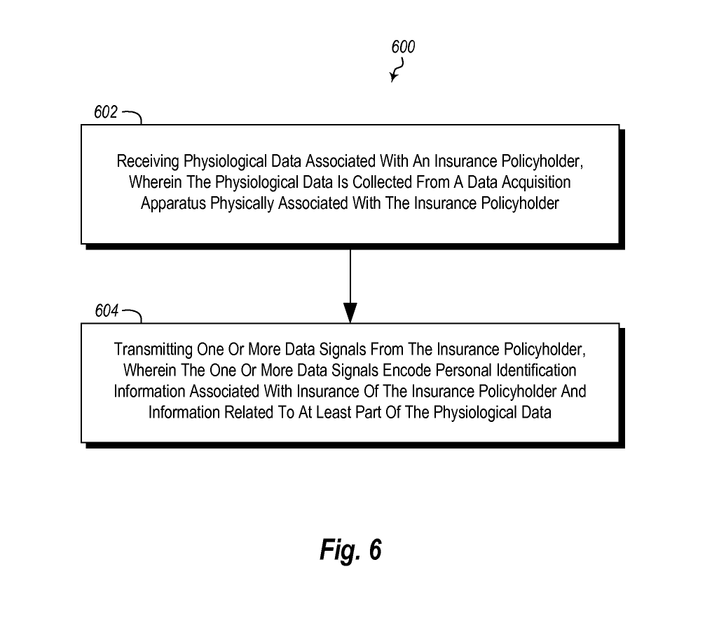

In addition to the various data acquisition apparatuses, systems, and components disclosed herein, the disclosed subject matter also includes various embodiments of methods of using such data acquisition apparatuses, systems, and components. FIG. 6 is a flow diagram illustrating an embodiment of a method 600 that may be implemented by any of the data acquisition apparatuses disclosed herein. The method 600 includes an act 602 of receiving physiological data. The physiological data acquired may include, for example, heart rate of the insurance policyholder, blood-alcohol content of the insurance policyholder, blood chemistry of the insurance policyholder, or blood pressure of the insurance policyholder. In the act 602, the physiological data is collected from a data acquisition apparatus physically associated with the insurance policyholder, such as the data acquisition apparatuses 102, 102′, 400, or 500 that may be implanted or worn by the insurance policyholder.

The method 600 further includes an act 604 of transmitting one or more data signals from the insurance policyholder, such as the one or more insurance data signals 122, 418, or 518. The one or more data signals encode PII associated with insurance of the insurance policyholder and information related to at least part of the physiological data. For example, the transmitting may occur wirelessly or via a hardware connection. As previously described with respect to the systems 300 and 300′ shown in FIGS. 3A and 3B, the one or more data signals may be transmitted directly to an insurer of the insurance covering the insurance policyholder (e.g., the insurer's computer system) or indirectly via a third-party server or router.

In an embodiment, the act 604 of transmitting occurs responsive to a query sent to the data acquisition apparatus from the insurer or a specified condition imposed by the insurer. For example, the data acquisition apparatus may be configured so that the act 604 of transmitting occurs on a predetermined schedule.

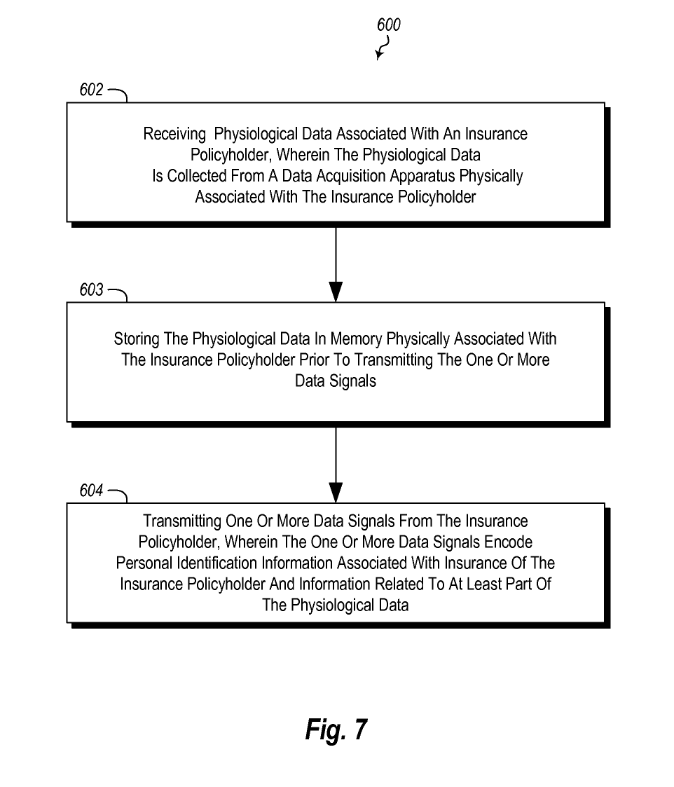

In an embodiment, the act 604 may occur substantially in real-time and without storage of the acquired data in memory of the data acquisition apparatus. However, in an embodiment shown in the flow chart of FIG. 7, the method 600 may further include an act 603 of storing the physiological data in memory physically associated with the insurance policyholder prior to act 604 of transmitting the one or more data signals. In such an embodiment, prior to the act 604 of transmitting, the information and the PII may be accessed from memory.

In an embodiment, the information acquired by the data acquisition apparatus may be compared to at least one predetermined condition or statistical analysis may be performed on the information. In such embodiment, the act 604 of transmitting includes transmitting information related to the comparison or the results of the statistical analysis.

Additional embodiments disclosed herein related to a computer program product configured to implement any of the methods described with respect to FIGS. 6 and 7. For example, the computer program product may include a computer readable medium (e.g., a recordable type medium or other storage medium) including computer executable instructions stored thereon that when executed by at least one processor perform any of the methods described with respect to FIGS. 6 and 7. For example, the method may include accessing information stored in memory of a data acquisition apparatus carried by an insurance policyholder, such as the memory 106 or 504 of the data acquisition apparatuses 102, 102′, 400, or 500. The information includes PII associated with insurance of the insurance policyholder. The method may further include directing a data transmitter to transmit one or more data signals out of the insurance policyholder. The one or more data signals encode the personal identification information and information related to at least part of physiological data from the insurance policyholder. The method may further include accessing the physiological data stored in the memory in addition to the PII.

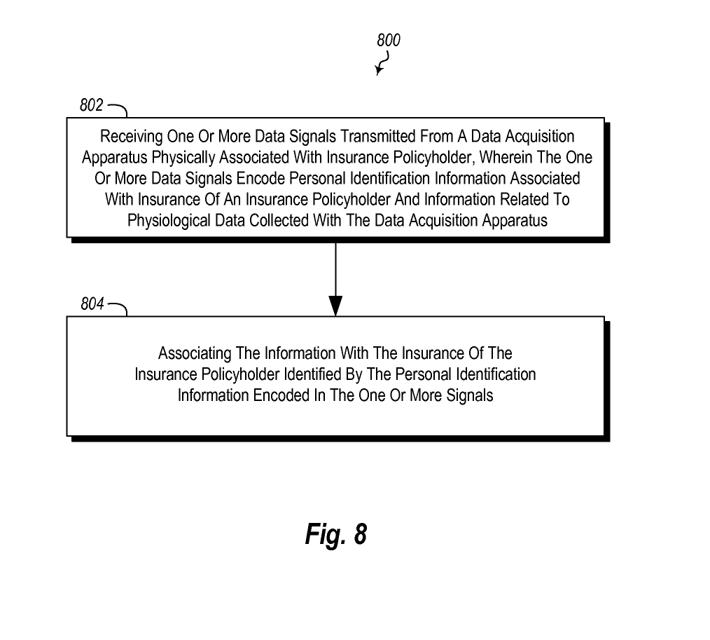

The disclosed subject matter also includes various embodiments of methods of using receiving and processing the data collected information at the insurer's computer system end. FIG. 8 is a flow diagram illustrating an embodiment of a method 800 that may be implemented by any of the insurer computer systems disclosed herein. The method 800 includes an act 802 of receiving one or more data signals (e.g. the one or more insurance data signals 122, 418, or 518) transmitted from a data acquisition apparatus carried by the insurance policyholder such as the data acquisition apparatuses 102, 102′, 400, or 500. The one or more data signals encode PII associated with insurance of an insurance policyholder and information related to physiological data collected with the data acquisition apparatus. For example, the one or more data signals may be received wirelessly or via a hardware electrical interface.

The method 800 further includes an act 804 of associating the information with the insurance of the insurance policyholder identified by the PII encoded in the one or more signals. In an embodiment, the act 804 further includes updating an insurance database with the information. For example, the associating may performed by processing electrical circuitry of the at least one processor 306 shown in FIGS. 3A and 3B.

The reader will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. The reader will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. The reader will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, the various embodiments described herein can be implemented, individually and/or collectively, by various types of electro-mechanical systems having a wide range of electrical components such as hardware, software, firmware, or virtually any combination thereof; and a wide range of components that may impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electronics systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context may dictate otherwise.

In a general sense, the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). The subject matter described herein may be implemented in an analog or digital fashion or some combination thereof.

The herein described components (e.g., steps), devices, and objects and the discussion accompanying them are used as examples for the sake of conceptual clarity. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, the reader can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

In some instances, one or more components may be referred to herein as “configured to.” The reader will recognize that “configured to” can generally encompass active-state components and/or inactive-state components and/or standby-state components, etc. unless context requires otherwise.

In some instances, one or more components may be referred to herein as “configured to.” The reader will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, the recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, the various aspects and embodiments disclosed herein are for purposes of illustration and are not intended to be limiting, with the true scope and spirit being indicated by the following claims.

1. A data acquisition apparatus for collecting insurance-related information, comprising:
memory including personal identification information stored thereon, wherein the personal identification information is associated with insurance of an insurance policyholder;
a data acquisition unit configured to acquire physiological data associated with the insurance policyholder, the data acquisition unit operably coupled to the memory, the memory being configured to store the acquired physiological data thereon;
at least one processor having access to the memory, the at least one processor configured to instruct a data transmitter to transmit one or more data signals from of the insurance policyholder, wherein the one or more data signals encode the personal identification information and information related to at least part of the acquired physiological data and
a biocompatible packaging enclosing the memory, the data acquisition unit, and the at least one processor, the biocompatible packaging being configured to be implanted into the insurance policyholder; or provisions configured to temporarily attach the data acquisition apparatus to the insurance policyholder.

2. (canceled)

3. The data acquisition apparatus of claim 1, wherein the acquired physiological data includes at least one of heart rate of the insurance policyholder, blood-alcohol content of the insurance policyholder, blood chemistry of the insurance policyholder, body temperature of the insurance policyholder, nerve activity of the insurance policyholder, speed of the insurance policyholder, or blood pressure of the insurance policyholder.

4. The data acquisition apparatus of claim 1, wherein the personal identification information includes at least one of an insurance policy number of the insurance policyholder, social security number of the insurance policyholder, a device identifier associated with the data acquisition unit, a name of an insurer insuring the insurance policyholder, or a name of the insurance policyholder.

5. The data acquisition apparatus of claim 1, wherein the data acquisition unit is configured to acquire the physiological data specified by an insurer of the insurance policyholder.

6. The data acquisition apparatus of claim 1, wherein the data acquisition unit includes at least one of a heart rate sensor, a blood-alcohol content sensor, a blood chemistry sensor, a blood pressure sensor, a temperature sensor, or a nerve activity sensor.

7. The data acquisition apparatus of claim 1, wherein the at least one processor includes a comparator configured to determine if the information related to the at least part of the acquired physiological data is a type of data specified by an insurer of the insurance policyholder, the memory configured to store the information related to the at least part of the acquired physiological data therein responsive to the comparator determining that the information related to the at least part of the acquired physiological data is the type of data specified by the insurer and to discard the information related to the at least part of the acquired physiological data responsive to determining that the information related to the at least part of the acquired physiological data is not the type of data specified by the insurer.

8. (canceled)

9. The data acquisition apparatus of claim 1, wherein the at least one processor includes a comparator configured to compare the information related to the at least part of the acquired physiological data to a predetermined condition.

10. The data acquisition apparatus of claim 9, wherein the predetermined condition is at least partially based upon a plurality of the acquired physiological data values.

11. The data acquisition apparatus of claim 1, further comprising the data transmitter operably coupled to the at least one processor, the data transmitter configured to transmit one or more data signals encoding the personal identification information, and the information related to the at least part of the acquired physiological data.

12. (canceled)

13. (canceled)

14. (canceled)

15. The data acquisition apparatus of claim 1, further comprising a receiver operably coupled to the data acquisition unit, the receiver configured to send new operating instructions to the data acquisition unit.

16. The data acquisition apparatus of claim 1, further comprising the data transmitter operably coupled to the at least one processor, the data transmitter configured to transmit one or more data signals encoding the personal identification information, and a comparison of the at least part of the acquired physiological data with a predetermined condition or the information related to the at least part of the acquired physiological data.

17. The data acquisition apparatus of claim 1, wherein the at least one processor is configured to perform statistical analysis on the at least part of the acquired physiological data.

18. The data acquisition apparatus of claim 1, further comprising the data acquisition configured to transmit the one or more data signals responsive to a query or a specified condition.

19. The data acquisition apparatus of claim 1, further comprising the data acquisition configured to transmit the one or more data signals based on a schedule.

20. (canceled)

21. (canceled)

22. A data acquisition apparatus for collecting insurance-related information, comprising:
memory including personal identification information stored thereon, wherein the personal identification information is associated with insurance of an insurance policyholder;
a data acquisition unit configured to acquire physiological data associated with the insurance policyholder;
a data transmitter having access to the memory and coupled to the data acquisition unit, the data transmitter configured to transmit one or more data signals from of the insurance policyholder, wherein the one or more data signals encode the personal identification information and information related to at least part of the acquired physiological data and
a biocompatible packaging enclosing the memory, the data acquisition unit, and the data transmitter, the biocompatible packaging being configured to be implanted into the insurance policyholder; or provisions configured to temporarily attach the data acquisition apparatus to the insurance policyholder.

23. (canceled)

24. The data acquisition apparatus of claim 22, wherein the memory is configured to store the acquired physiological data thereon.

25. The data acquisition apparatus of claim 22, wherein the acquired physiological data includes at least one of heart rate of the insurance policyholder, blood-alcohol content of the insurance policyholder, blood chemistry of the insurance policyholder, body temperature of the insurance policyholder, nerve activity of the insurance policyholder, or blood pressure of the insurance policyholder.

26. The data acquisition apparatus of claim 22, wherein the personal identification information includes at least one of an insurance policy number of the insurance policyholder, social security number of the insurance policyholder, a device identifier associated with the data acquisition unit, a name of an insurer insuring the insurance policyholder, or a name of the insurance policyholder.

27. The data acquisition apparatus of claim 22, wherein the data acquisition unit includes at least one of a heart rate sensor, a blood-alcohol content sensor, a blood chemistry sensor, a blood pressure sensor, a temperature sensor, or a nerve activity sensor.

28. The data acquisition apparatus of claim 22, wherein the data acquisition unit is configured to acquire the physiological data specified by an insurer of the insurance policyholder.

29. (canceled)

30. (canceled)

31. (canceled)

32. The data acquisition apparatus of claim 22, further comprising a comparator configured to determine if the information related to the at least part of the acquired physiological data is a type of data specified by an insurer of the insurance policyholder, the memory configured to store the information related to the at least part of the acquired physiological data therein responsive to the comparator determining that the information related to the at least part of the acquired physiological data is the type of data specified by the insurer and to discard the information related to the at least part of the acquired physiological data responsive to determining that the information related to the at least part of the acquired physiological data is not the type of data specified by the insurer.

33. (canceled)

34. The data acquisition apparatus of claim 22, further comprising a comparator configured to compare the information related to the at least part of the acquired physiological data to a predetermined condition.

35. The data acquisition apparatus of claim 34, wherein the predetermined condition is at least partially based upon a plurality of the acquired physiological data values.

36. The data acquisition apparatus of claim 22, further comprising a receiver operably coupled to the data acquisition unit, the receiver configured to send new operating instructions to the data acquisition unit.

37. The data acquisition apparatus of claim 22, further comprising at least one processor configured to perform statistical analysis on the at least part of the acquired physiological data.

38. The data acquisition apparatus of claim 22, wherein the data acquisition configured to transmit the one or more data signals responsive to a query or a specified condition.

39. The data acquisition apparatus of claim 22, wherein the data acquisition configured to transmit the one or more data signals based on a schedule.

40. (canceled)

41. (canceled)

42. (canceled)

43. (canceled)

44. (canceled)

45. (canceled)

46. (canceled)

47. (canceled)

48. (canceled)

49. (canceled)

50. A system, comprising:
a data acquisition apparatus configured to be physically associated with an insurance policyholder, the data acquisition unit including,
memory having personal identification information stored thereon, wherein the personal identification information is associated with insurance of the insurance policyholder;
a data acquisition unit configured to acquire physiological data associated with the insurance policyholder;
a data transmitter operably coupled to the data acquisition unit and the memory, the data transmitter configured to transmit one or more data signals, wherein the one or more data signals encode the personal identification information and information related to at least part of the acquired physiological data; and
a biocompatible packaging enclosing the memory, the data acquisition unit, and the data transmitter, the biocompatible packaging being configured to be implanted into the insurance policyholder; or provisions configured to temporarily attach the data acquisition apparatus to the insurance policyholder; and
a computing device including,
a data receiver configured to receive the one or more data signals; and
memory having an insurance database stored thereon, the insurance database including information about the insurance of the insurance policyholder.

51. The system of claim 50, wherein the computing device includes processing electrical circuitry configured to associate the information related to the at least part of the acquired physiological data with the insurance of the insurance policyholder.

52. The system of claim 50, wherein the computing device includes processing electrical circuitry configured to calculate an adjusted insurance rate based at least partially on information related to the at least part of the acquired physiological data associated with the insurance policyholder.

53. The system of claim 50, wherein the data acquisition unit of the data acquisition apparatus is coupled to the memory to store the information related to the at least part of the acquired physiological data.

54. (canceled)

55. The system of claim 50, wherein the acquired physiological data includes at least one of heart rate of the insurance policyholder, blood-alcohol content of the insurance policyholder, blood chemistry of the insurance policyholder, body temperature of the insurance policyholder, nerve activity of the insurance policyholder, speed of the insurance policyholder, blood pressure of the insurance policyholder, or time at which the acquired physiological data is acquired.

56. The system of claim 50, wherein the personal identification information includes at least one of an insurance policy number of the insurance policyholder, social security number of the insurance policyholder, a device identifier associated with the data acquisition unit, a name of an insurer insuring the insurance policyholder, or a name of the insurance policyholder.

57. The system of claim 50, wherein the data acquisition unit includes at least one of a heart rate sensor, a blood-alcohol content sensor, a blood chemistry sensor, a blood pressure sensor, a temperature sensor, or a nerve activity sensor.

58. The system of claim 50, wherein the data acquisition apparatus is configured to acquire the physiological data specified by an insurer of the insurance policyholder.

59. (canceled)

60. (canceled)

61. The system of claim 50, wherein the data acquisition apparatus includes a comparator configured to compare the information related to the at least part of the acquired physiological data to a predetermined condition.

62. The system of claim 61, wherein the predetermined condition includes a plurality of different predetermined conditions.

63. (canceled)

64. (canceled)

65. (canceled)

66. (canceled)

67. A method, comprising:
at a physiological data acquisition unit, receiving physiological data associated with an insurance policyholder, wherein the physiological data is collected from the physiological data acquisition apparatus implanted in or worn by the insurance policyholder; and
with a data transmitter, transmitting one or more data signals from the physiological data acquisition apparatus implanted in or worn by the insurance policyholder, wherein the one or more data signals encode personal identification information associated with insurance of the insurance policyholder and information related to at least part of the physiological data.

68. The method of claim 67, further comprising storing the physiological data in memory physically associated with the insurance policyholder prior to the transmitting the one or more data signals.

69. The method of claim 67, wherein transmitting includes transmitting the one or more data signals out of the insurance policyholder in real-time.

70. The method of claim 67, wherein the acquired physiological data includes at least one of heart rate, blood-alcohol content, blood chemistry, or blood pressure of the insurance policyholder.

71. (canceled)

72. (canceled)

73. (canceled)

74. (canceled)

75. The method of claim 67, wherein the transmitting occurs responsive to a query or a specified condition.

76. The method of claim 67, wherein the transmitting occurs on a predetermined schedule.

77. The method of claim 67, further comprising accessing the information and the personal identification information from memory prior to the transmitting.

78. The method of claim 67, further comprising comparing the information to at least one predetermined condition, and wherein the transmitting includes transmitting information related to the comparison.

79. A method, comprising:
receiving one or more data signals transmitted from a physiological data acquisition apparatus implanted in or worn by the insurance policyholder, wherein the one or more data signals encode personal identification information associated with insurance of an insurance policyholder and information related to physiological data collected with the physiological data acquisition apparatus; and
with a computing device, associating the information with the insurance of the insurance policyholder identified by the personal identification information encoded in the one or more signals.

80. The method of claim 79, wherein the associating includes updating an insurance database with the information.

81. (canceled)

82. The method of claim 79, wherein receiving one or more data signals transmitted from a data acquisition apparatus physically associated with the insurance policyholder includes wirelessly receiving the one or more data signals output from the data acquisition apparatus.

83. The method of claim 79, wherein receiving one or more data signals transmitted from a data acquisition apparatus physically associated with the insurance policyholder includes receiving the one or more data signals output from an electrical interface of the data acquisition apparatus.
